(19) United States
(12) Patent Application Publication
(10) Pub. No.: US 2020/0257135 A1
(43) Pub. Date: Aug. 13, 2020

(54) Modular Eyewear

(71) Applicants: Danielle Ringle, Los Angeles, CA (US); Zelba Ringle, Los Angeles, CA (US)

(72) Inventors: Danielle Ringle, Los Angeles, CA (US); Zelba Ringle, Los Angeles, CA (US)

(21) Appl. No.: 16/862,970

(22) Filed: Apr. 30, 2020

Related U.S. Application Data
(63) Continuation-in-part of application No. 15/707,983, filed on Sep. 18, 2017.

(51) Int. Cl. G02C 5/22

(52) U.S. Cl. CPC G02C 5/22; G02C 2200/02; G02C 2200/08

(57) ABSTRACT

The inventive subject matter presents novel modular eyewear, having an upper frame, a lower frame, and temple frames. Aspects of the invention include magnetic coupling points. At a first magnetic coupling point, the upper frame, lower frame, and temple frame couple. At a second magnetic coupling, the upper frame and lower frame magnetically couple at the bridge of the frame formed by the upper frame and lower frame. Embodiments include a coupling component to removably attach a temple frame to the upper or lower frame of modular eyewear while still allowing the temple frames to fold like ordinary eyewear. Thus, the present invention enables the upper frame and lower frame to affix a lens for the benefit of the wearer and enables greater flexibility, customizability, reduction of wear and tear, and user experience.

This application is a continuation in part and claims priority to U.S. patent application Ser. No. 15/707,983 filed Sep. 18, 2017.

### FIELD OF THE INVENTION

The field of the invention is modular eyewear.

### BACKGROUND

The background description includes information that may be useful in understanding the present invention. It is not an admission that any of the information provided in this application is prior art or relevant to the presently claimed invention, or that any publication specifically or implicitly referenced is prior art.

While many devices exist in the field of modular eyewear, there has yet to exist a device that accomplishes simple disassembly, which achieves, e.g., simple changing of lenses, and re-assembly, in a manner that minimizes the number of parts that may be lost during disassembly and re-assembly and has other advantages that will become apparent in this application.

U.S. Pat. No. 9,454,017, for example, is directed to modular eyewear adapted to quickly release. But the disclosure includes lenses that require a specialized slot to quickly decouple, as well as a decoupling mechanism that includes many parts not designed to enable decoupling without specialized tools or in non-ideal environments. Further, the coupling of the temple frame pieces in the '017 patent's disclosure are not described to audibly snap, thus failing to provide a human assembler with auditory feedback to confirm assembly.

U.S. Patent Publication No. 2009/0195747 describes temple holders each having recesses formed in the holders that are hinged to the extreme ends of an eyeglass front. This publication fails to teach a fully modular eyewear frame, and also fails to teach a magnetic male end on the temple frame that affixes to a female end on the upper eyewear frame, which enables a hingeless modular eyewear design and, even in cases where a design may include hinges, reduces the wear and tear caused by operating the hinge. Other teachings lacking in this patent publication are evident by comparison to the present invention.

As another example, U.S. Patent Publication No. 2014/0104562, describes affixing a temple frame to the eyewear frame through special design of a hinge. This publication, too, fails to teach a fully modular eyewear frame, and also fails to teach a magnetic male end on the temple frame that affixes to a female end on the upper eyewear frame, which enables a hingeless modular eyewear design and, even in cases where a design may include hinges, reduces the wear and tear caused by operating the hinge. Other teachings lacking in this patent publication are evident by comparison to the present invention.

Thus, the background materials discussed in this application fail to teach or suggest a fully modular eyewear apparatus. For example, the background materials fail to teach a main eyewear frame comprising an upper and a lower portion configured to magnetically couple to affix a lens. Other teachings lacking in the background materials are evident by comparison to the present invention. The invention described in this application provides several advantages over the prior art, including, e.g., enabling reduced wear and tear through elimination or lower use of mechanical hinges, greater customizability, improved user experience, and improved assembly and disassembly.

The foregoing discussion is for background purposes only; it is not an admission that any aspect of the background is prior art.

### SUMMARY OF THE INVENTION

The present invention provides modular eyewear with magnetic couplings.

In one aspect of the inventive subject matter an eyewear hinge piece is contemplated, the eyewear hinge piece comprising: a protrusion and a hinge portion extending from the protrusion, where the protrusion has at least one flat side configured to prevent rotation of the eyewear hinge piece upon inserting the protrusion into a complementary cavity; where the hinge portion comprises a flat top surface and a flat bottom surface with a through hole passing through the hinge portion; where the hinge portion comprises a through hole; and where the protrusion and the hinge portion extend in opposite directions from one another.

In some embodiments, the eyewear hinge also has a temple frame having a hinge part coupled to it and an upper frame comprising a cup-shaped component, the cup-shaped component creating the complementary cavity. The protrusion can thus be sized and dimensioned to fit within the complementary cavity of the cup-shaped component, and the hinge part can include a flat top portion and a flat bottom portion with the hinge portion being sized and dimensioned to fit between the flat top part and the flat bottom part.

In some embodiments, the cup-shaped component has at least one internal flat surface within the complementary cavity that interacts with the at least one flat side of the protrusion to prevent rotation of the eyewear hinge piece relative to the cup-shaped component. In some embodiments, the cup-shaped component can be made from a magnet while the protrusion is made from a material that is subject to induced magnetization. In other embodiments, the cup-shaped component is made from a material that is subject to induced magnetization and the protrusion is made from a magnet. Finally, it is possible for both the cup-shaped component and the protrusion to be made from magnets.

In another aspect of the inventive subject matter, modular eyewear is contemplated. The modular eyewear includes: an upper frame comprising a cup-shaped magnet having at least one flat interior surface; a right temple frame having a hinge, the hinge comprising a first hinge part and a second hinge part; the first hinge part coupling with the temple frame, wherein the first hinge part comprises a first coupling portion having a first through hole; the second hinge part comprising a protrusion and a second coupling portion having a second through hole, where the second coupling portion extends from the protrusion; where the second coupling portion is configured to rotatably couple with the first coupling portion by a fastener passing through the first through hole and the second through hole; where the protrusion is sized and dimensioned to couple with the cup-shaped magnet by fitting within an interior space of the cup-shaped magnet; wherein the protrusion has at least one flat surface configured to interact with the at least one flat interior surface upon coupling the protrusion with the cup-shaped magnet to prevent rotation of the second hinge part relative to the cup-shaped magnet.

In some embodiments, the cup-shaped magnet comprises at least one internal flat surface that interacts with the at least one flat side of the protrusion to prevent rotation of the eyewear hinge piece relative to the cup-shaped magnet. In some embodiments, the protrusion can be made from a material that is subject to induced magnetization, while in other embodiments, the protrusion is made from a magnet. It can also include non-magnetic material, or any combination of a magnet, a material subject to induced magnetization, or a non-magnetic material.

In another aspect, modular eyewear is contemplated, the modular eyewear comprising: an upper frame comprising a cup-shaped component having an interior space with a first cross-sectional shape; a right temple frame having a hinge, the hinge comprising a first hinge part and a second hinge part; the first hinge part coupling with the temple frame, where the first hinge part has a first coupling portion with a first through hole; the second hinge part having a protrusion and a second coupling portion having a second through hole, where the second coupling portion extends from the protrusion; where the second coupling portion is configured to rotatably couple with the first coupling portion by a fastener passing through the first through hole and the second through hole; the protrusion having a second cross-sectional shape that is the same as the first cross-sectional shape. The protrusion is sized and dimensioned such that the protrusion fits within the interior space of the cup-shaped component, and the first and second cross-sectional shapes are configured to prevent rotation of the second hinge part relative to the cup-shaped component upon inserting the protrusion into the interior space

In some embodiments, the cup-shaped component comprises a magnet and the protrusion comprises a material that is subject to induced magnetization, while in other embodiments, the cup-shaped component comprises a material that is subject to induced magnetization and the protrusion comprises a magnet. In other embodiments, both the cup-shaped magnet and the protrusion can be made with magnets. Non-magnetic materials can also be used in combination with magnets, materials subject to induced magnetization, or a combination of both to create these components. In some embodiments,

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a front view of the frame.

FIG. 2 is a perspective view of the temple frame.

FIG. 3 is a perspective view of a temple magnet.

FIG. 4 is a cross-sectional view of the temple magnet.

FIG. 5 is a cross-sectional view of a temple frame magnet.

FIG. 6A is a cross-sectional view of a magnet for use as a bridge magnet and lower frame temple magnet.

FIG. 6B is a cross-sectional view of another magnet for use as a bridge magnet and lower frame temple magnet.

FIG. 7 is a top view of the temple frame coupled with temple frame magnet.

FIG. 8 shows an embodiment having a coupling mechanism of the inventive subject matter incorporated therein.

FIG. 9 shows front view of a hinge part.

FIG. 10 shows top view of a hinge part.

FIG. 11 shows a coupling mechanism of the inventive subject matter.

FIG. 12 shows a front view of the coupling mechanism of FIG. 11.

FIG. 13 shows a rear view of the coupling mechanism of FIG. 11.

FIG. 14 shows a side view of the coupling mechanism of FIG. 11.

FIG. 15 shows the coupling mechanism of FIG. 11 when it is coupled with the hinge part of FIGS. 9-10.

FIG. 16 shows the coupling mechanism of FIG. 11 when it is coupled with the hinge part of FIGS. 9-10, while the hinge part is further coupled with a temple frame.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In one embodiment of the inventive subject matter, modular eyewear comprises a top frame piece, a bottom frame piece, a right temple piece, and a left temple piece. The modular eyewear is configured to permit each piece to easily disassemble or reassemble, such that, when assembled, the top frame piece and bottom frame piece joined together affix lenses between them.

The assembly is accomplished through coupling points at the temples and bridge of the frame. In some embodiments of the inventive subject matter, the coupling point at the temples is accomplished through magnetic and mechanical coupling.

Embodiments of the inventive subject matter will now be described by reference to the Figures.

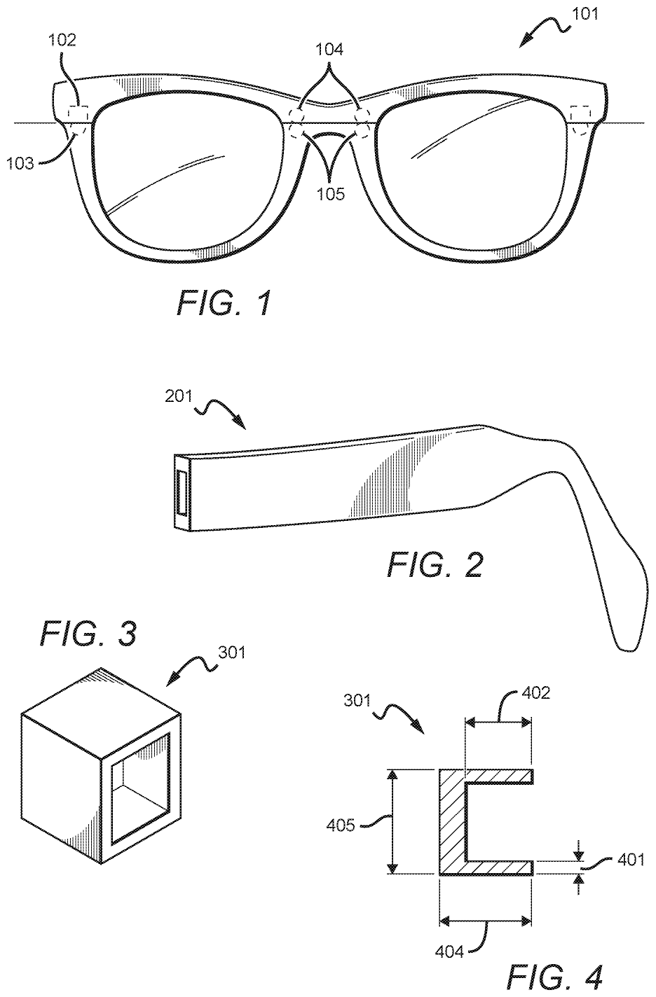

FIG. 1 depicts the upper frame and the lower frame coupled together to form frame 101. The coupling is accomplished at a first coupling point, through the magnetic coupling of upper frame temple magnet 102 and lower frame temple magnet 103. The coupling is further accomplished at a second coupling point, through the magnetic coupling of bridge magnets 104 on the upper frame and bridge magnets 105 on the lower frame. In some embodiments, the upper frame and lower frame may be configured to audibly snap when coupled.

FIG. 2 depicts the temple frame 201. The temple frame comprises a slot into which a temple frame magnet may be inserted. When the magnet is inserted, the temple frame is configured to couple with frame 101 at the first coupling point. In some embodiments, the temple frame is configured to audibly snap when coupled with frame 101. The temple frame design thus enables modular eyewear that does not require hinges at the temples, enabling cheaper manufacturing and fewer moving mechanical parts that may wear out over time.

FIG. 3 depicts a magnet 301, which is one example of upper frame temple magnet 102. Magnet 301 has a U-shaped cross section, as depicted in FIG. 4. In some embodiments, the U-shaped cross section has particular dimensions at particular points to achieve superior magnetic and mechanical coupling. Although many lengths are contemplated, in some embodiments, lengths 401 are smaller than 3 mm (preferably around 1.25 mm), depth 402 is smaller than 8 mm (preferably around 4.5 mm), height 405 is smaller than 8 mm (preferably around 4.5 mm), and length 404 is also smaller than 8 mm (preferably around 5.5 mm). The height of the opening is therefore dictated by heights 405 and 401. Lengths 401, 402, 404, and 405 are each sized sufficiently to prevent the material from snapping or otherwise wearing out. In some embodiments, lengths 401 are different on the different sides of the open cube shape formed by magnet 301.

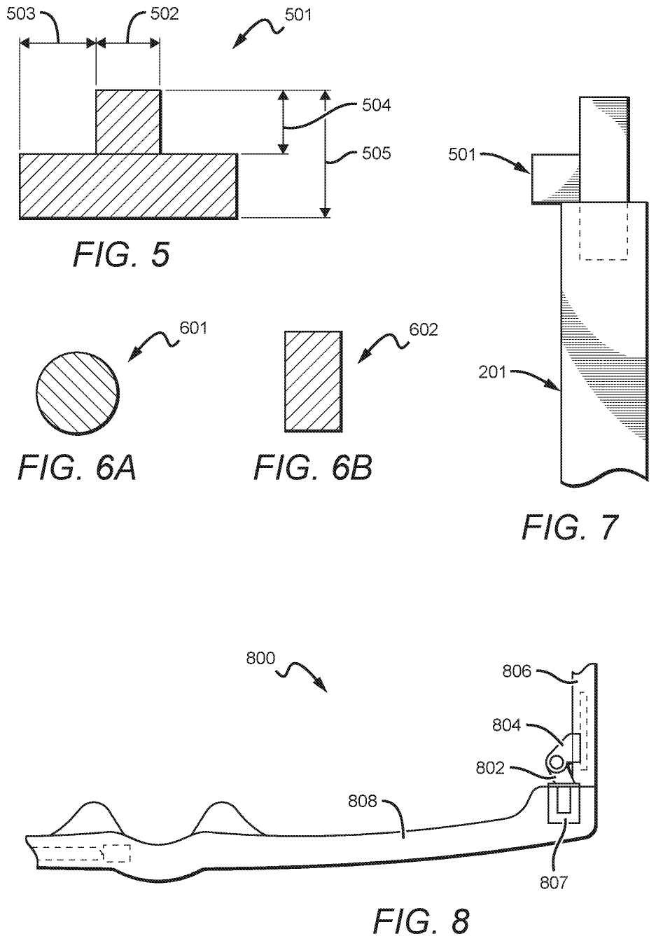

FIG. 5 depicts one example of a temple frame magnet 501 which may be inserted into temple frame 201. Temple frame magnet 501 has a first rectangular prism portion and a second rectangular prism portion, cross-sections of which are depicted in FIG. 5. In some embodiments, the two portions comprise different magnets coupled together through a magnetic and physical, e.g., adhesive, coupling. In some embodiments, upper length 502 is smaller than 3 mm, upper distance 503 is smaller than 4 mm, upper distance 504 is smaller than 3 mm, lower length 505 is smaller than 6 mm. Temple frame magnet 501 is configured to couple with magnet 301, and also to couple with lower frame temple magnet 103.

FIG. 6A depicts one example of disc magnet 601, which in some embodiments may be used as lower frame temple magnet 103 and bridge magnets 104 in both the upper frame and the lower frame. In some embodiments, the major diameter of the disc magnet 601 is less than 4 mm. FIG. 6B shows a rectangular magnet 602 that can be used in place of disc-shaped magnets shown in FIG. 6A. Any other shape magnet can be implemented so long as the magnet is sufficiently strong to couple two portions of modular eyewear together.

FIG. 7 depicts the temple frame 201 coupled with magnet 301 as the temple frame magnet. The coupling may be accomplished physically, e.g., by addition of an adhesive or special molding process with temple frame 201.

In some embodiments, instead of the temple frame magnet described above in relation to at least FIGS. 5 and 7, a coupling mechanism that includes a protrusion to couple with a cup-shaped temple magnet-described above in relation to FIG. 3—can be implemented. FIGS. 8-11 show an embodiment of such a coupling mechanism. The cup-shaped magnet (or, in some embodiments, cup-shaped component when it is not made from a magnetic material) features an interior space (the space shown facing the paper in FIG. 3). As shown in FIG. 3, the cup-shaped component has a cross-sectional shape of a square, though other cross-sectional shapes are contemplated in this application, so long as the cross-sectional shape selected prevents rotation of the component that mates with the cup-shaped component.

FIG. 8 shows a coupling mechanism 802 implemented in a set of modular eyewear 800. The coupling mechanism 802 couples with a hinge part 804 that is coupled with the temple frame 806 via a cup-shaped magnet 807. The coupling mechanism 802 can, e.g., take the place of the temple frame magnet as demonstrated in this Figure. When the coupling mechanism 802 is coupled with the hinge mechanism 804, they create a hinge that allows the temple frame 806 to be removably coupled with the upper frame 808. The cup-shaped magnet 807 depicted in FIG. 8 is shown in a cutaway view to demonstrate how the protrusion on the coupling mechanism 802 fits within the interior space of the cup-shaped magnet 807. The cup-shaped magnet 807 shown in FIG. 8 is also described above in FIGS. 3 & 4.

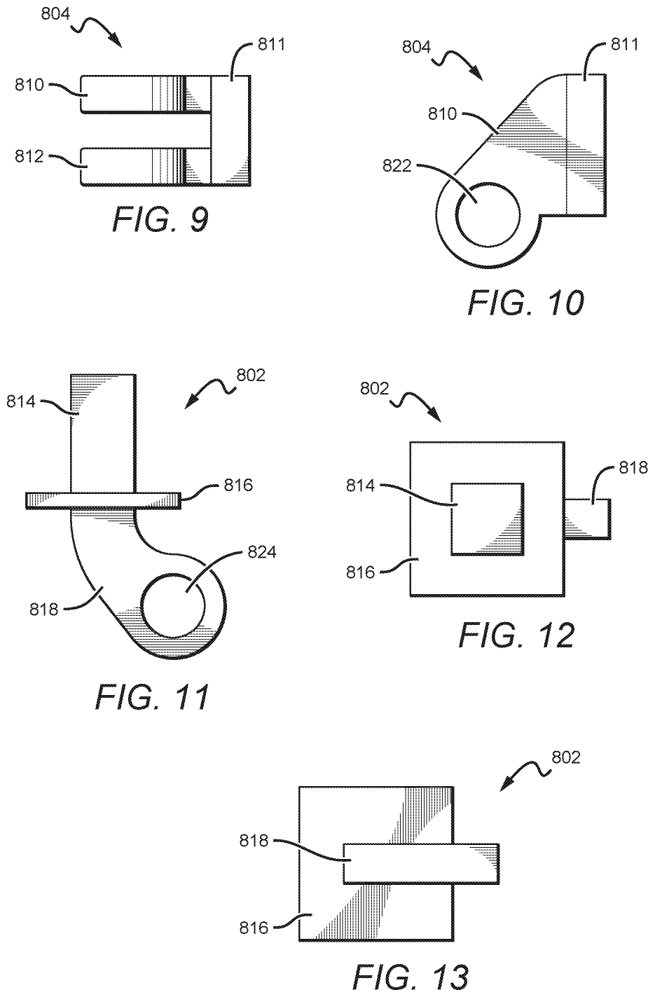

Hinge part 804 has a portion that couples with the temple frame and another protruding portion having a through hole. The protrusion of the hinge part 804 can include a top portion and a bottom portion with a cutout middle (e.g., creating a space in between for a complementary part from the coupling mechanism 802 to fit within). FIG. 9 shows a side view of the hinge part 804 in a way that shows off the protrusion's top portion 810 and bottom portion 812. Both the top portion and the bottom portion feature a through hole (both denoted as 822), as mentioned above, that allows screw 820 to pass through the top portion 810 and the bottom portion 812 to connect the coupling mechanism 802 to the hinge part 804.

FIG. 10 shows a top view of the hinge part 804, making the through hole 822 visible. The hinge part features a mounting portion 811 as seen in FIGS. 9 and 10. When the hinge part 804 is attached to temple frame 806, the mounting portion 811 can be, e.g., coupled with a metal piece running a portion of the length of the temple frame 806 or it can be coupled with the plastic of the temple frame. In either case, mounting portion 811 can be either fully or partially disposed within the temple frame 806 to allow the hinge part 804 to couple with the coupling mechanism 802, which can further couple with the cup-shaped magnet 807. In some embodiments, the top portion's through hole can include internal threading. The bottom portion's through hole can also include internal threading. In some embodiments, both the top portion and the bottom portion are threaded.

FIG. 11 shows the coupling mechanism 802. In embodiments, the coupling mechanism 802 is made from a single material, but in some embodiments, different materials can make up different portions of the coupling mechanism 802. The coupling mechanism 802 includes a coupling protrusion 814, a flared portion 816, and a hinge portion 818. Hinge portion 818 includes a through hole that is configured for a screw to pass through both the through hole 824 in the coupling mechanism and the through holes in the hinge part 804. FIGS. 11-14 show different views of the coupling mechanism 802 to facilitate discussion and description of the different features.

In some embodiments, at least coupling protrusion 814 is made from either a magnetic material (e.g., a permanent magnet of some kind) or from a material that can be subject to induced magnetism (e.g., stainless steel or any other type of steel). In some embodiments, the entirety of the coupling protrusion 814 can be made from either a magnetic material or a material that can be subject to induced magnetism. Similarly, the cup-shaped magnet 807 described regarding FIG. 3 can be made from either a magnetic material or a material that can be subject to induced magnetization. Because the coupling protrusion 814 is configured to fit within the cup-shaped magnet 807 to couple the two components together to prevent accidental decoupling, if the coupling protrusion (or the entire coupling mechanism) is made from a magnetic material, then the cup-shaped magnet can be made from a material that can be subject to induced magnetization instead of a magnet (e.g., making it a “cup-shaped component” rather than a “cup-shaped magnet”). The corollary is also true: if the cup-shaped component is formed as a magnet (making it once again a “cup-shaped magnet”), then the coupling protrusion 814 can be made from a material that can be subject to induced magnetization instead of being made from a magnet itself. In some embodiments, both the cup-shaped component and the coupling protrusion are made from magnetic materials with their poles oriented to facilitate coupling.

FIG. 12 shows a front view of the coupling mechanism 802. This view shows that the coupling portion 814 and the flared portion 816 can have square-shaped cross-sections (e.g., the cross-sectional shape of the protrusion as seen in FIG. 12). Other shapes can also be implemented. Embodiments having only a single coupling portion as shown in FIGS. 11-14 should include at least one flat surface on a side surface of the coupling portion (e.g., a side portion references a portion perpendicular to the page as shown in FIG. 12), where the cross-sectional shape matches the cross-sectional shape of the intrusion of a corresponding cup-shaped magnet (e.g., the interior of the cup portion). Having at least one flat surface (on a surface other than the surface facing the paper as shown in FIG. 12) prevents the coupling mechanism from rotating with respect to the cup-shaped magnet. This, in turn, prevents the temple frame from rotating with respect to the upper frame that it couples with.

In some embodiments, the protrusion does not have a square cross-section, nor does it necessarily need to include at least one flat surface. The protrusion can feature a different cross-sectional shape so long as the cup-shaped component that it couples with has a complementary shape for the protrusion to fit into and such that the protrusion cannot rotate relative to the cup-shaped component upon coupling. For example, if the protrusion has an oval cross section, then it could fit into an oval cavity in the cup-shaped component, which would prevent the pieces from rotating relative to each other. Other shapes bringing about the same function of preventing rotation are similarly contemplated.

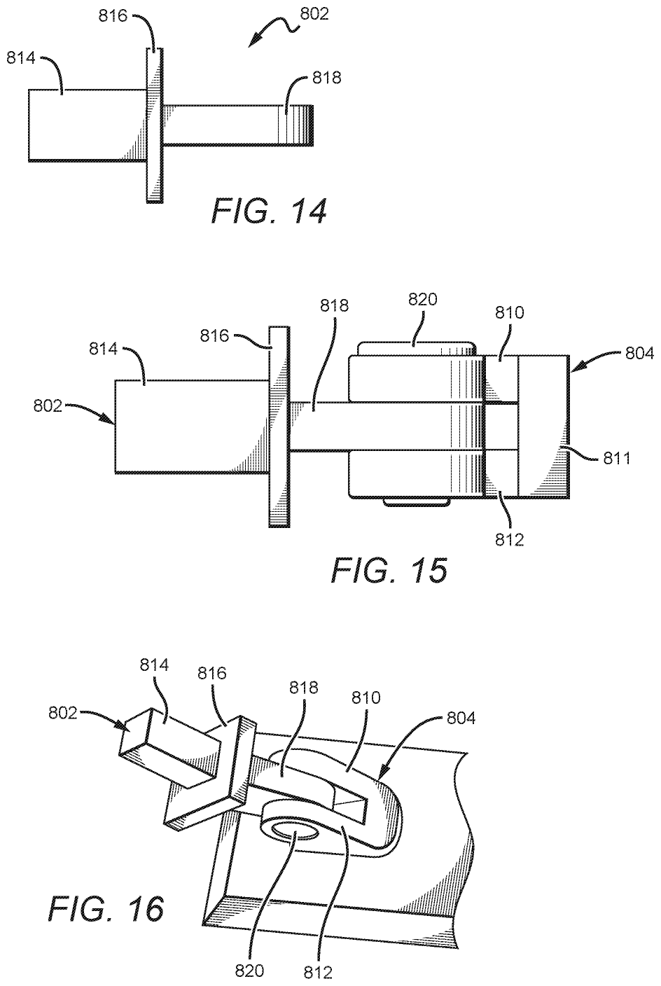

FIG. 13 shows a rear view of the coupling mechanism 802, where the coupling portion 814 is not visible behind the flared portion 816. The hinge portion 818 that extends from the flared portion 816 is visible. FIG. 14 shows a side view of the coupling mechanism 802, showing the coupling portion 814, the flared portion 816, and the hinge portion 818. In some embodiments, the coupling mechanism 802 does not include a flared portion and instead just features a hinge portion coupled with a coupling portion.

FIG. 15 shows a coupling mechanism 802 when it is coupled with hinge part 804. The top portion 810 and the bottom portion 812 of the hinge part 804 have the hinge portion 818 disposed between them. Fastener 820 holds the coupling mechanism 802 with hinge part 804 such that the components can rotate relative to one another about an axis running through fastener 820. To couple the hinge part 804 to the coupling mechanism 802, fastener 820 passes through the through holes 822 in the hinge part 804 as well as the through hole 824 in the hinge portion 818 of the coupling mechanism 802. In some embodiments, fastener 820 is a screw (e.g., a screw commonly used to hold two sides of a glasses hinge together), but fastener 820 can also be a pin, dowel, nut and bolt, etc. In embodiments where fastener 820 includes external threading, the interior sides of through holes in both the coupling mechanism 802 and the hinge part 804 can be threaded as described above.

FIG. 16 shows an additional view of coupling mechanism 802 when it is coupled with hinge part 804 by a fastener 820 where the hinge part 804 is additionally coupled with a temple frame. When the coupling mechanism 802 and hinge part 804 are coupled in this way, the coupling protrusion 814 of the coupling mechanism 802 can be snapped into (e.g., magnetically coupled with) the cup-shaped magnet to couple a temple frame with, e.g., the upper frame of a pair of glasses of the inventive subject matter (as shown in FIG. 8).

Thus, specific compositions and methods of the invention have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An eyewear hinge piece, comprising:
a protrusion;
a hinge portion extending from the protrusion;
wherein the protrusion comprises at least one flat side configured to prevent rotation of the eyewear hinge piece upon inserting the protrusion into a complementary cavity;
wherein the hinge portion comprises a flat top surface and a flat bottom surface with a through hole passing through the hinge portion;
wherein the hinge portion comprises a through hole; and
wherein the protrusion and the hinge portion extend in opposite directions from one another.

2. The eyewear hinge piece of claim 1, further comprising
a temple frame having a hinge part coupled thereto;
an upper frame comprising a cup-shaped component, the cup-shaped component creating the complementary cavity;
wherein the protrusion is sized and dimensioned to fit within the complementary cavity of the cup-shaped component; and
wherein the hinge part comprises a flat top portion and a flat bottom portion, and wherein the hinge portion is sized and dimensioned to fit between the flat top part and the flat bottom part.

3. The eyewear hinge piece of claim 2, wherein the cup-shaped component comprises at least one internal flat surface that interacts with the at least one flat side of the protrusion to prevent rotation of the eyewear hinge piece relative to the cup-shaped component.

4. The eyewear hinge piece of claim 2, wherein the cup-shaped component comprises a magnet and the protrusion comprises a material that is subject to induced magnetization.

5. The eyewear hinge piece of claim 2, wherein the cup-shaped component comprises a material that is subject to induced magnetization and the protrusion comprises a magnet.

6. The eyewear hinge piece of claim 2, wherein the cup-shaped component comprises a first magnet and the protrusion comprises a second magnet.

7. Modular eyewear, comprising:
an upper frame comprising a cup-shaped magnet having at least one flat interior surface;
a right temple frame having a hinge, the hinge comprising a first hinge part and a second hinge part;
the first hinge part coupling with the temple frame, wherein the first hinge part comprises a first coupling portion having a first through hole;
the second hinge part comprising a protrusion and a second coupling portion having a second through hole, where the second coupling portion extends from the protrusion;
wherein the second coupling portion is configured to rotatably couple with the first coupling portion by a fastener passing through the first through hole and the second through hole;
the protrusion being sized and dimensioned to couple with the cup-shaped magnet by fitting within an interior space of the cup-shaped magnet; and
wherein the protrusion has at least one flat surface configured to interact with the at least one flat interior surface upon coupling the protrusion with the cup-shaped magnet to prevent rotation of the second hinge part relative to the cup-shaped magnet.

8. The modular eyewear of claim 7, wherein the cup-shaped magnet comprises at least one internal flat surface that interacts with the at least one flat side of the protrusion to prevent rotation of the eyewear hinge piece relative to the cup-shaped magnet.

9. The modular eyewear of claim 7, wherein the protrusion comprises a material that is subject to induced magnetization.

10. The modular eyewear of claim 7, wherein the protrusion comprises a magnet.

11. Modular eyewear, comprising
an upper frame comprising a cup-shaped component having an interior space with a first cross-sectional shape;
a right temple frame having a hinge, the hinge comprising a first hinge part and a second hinge part;
the first hinge part coupling with the temple frame, wherein the first hinge part comprises a first coupling portion having a first through hole;
the second hinge part comprising a protrusion and a second coupling portion having a second through hole, where the second coupling portion extends from the protrusion;
wherein the second coupling portion is configured to rotatably couple with the first coupling portion by a fastener passing through the first through hole and the second through hole;
the protrusion having a second cross-sectional shape that is the same as the first cross-sectional shape;
wherein the protrusion is sized and dimensioned such that the protrusion fits within the interior space of the cup-shaped component; and
wherein the first and second cross-sectional shapes are configured to prevent rotation of the second hinge part relative to the cup-shaped component upon inserting the protrusion into the interior space.

12. The modular eyewear of claim 11, wherein the cup-shaped component comprises a magnet and the protrusion comprises a material that is subject to induced magnetization.

13. The modular eyewear of claim 11, wherein the cup-shaped component comprises a material that is subject to induced magnetization and the protrusion comprises a magnet.

14. The modular eyewear of claim 11, wherein the cup-shaped component comprises a first magnet and the protrusion comprises a second magnet.
